(19) United States
(12) Patent Application Publication
(10) Pub. No.: US 2005/0080846 A1
(43) Pub. Date: Apr. 14, 2005

(54) Method and system for updating digital content over a network

(75) Inventors: Scott McCleskey, American Fork, UT (US); Paul Charles, Scottsdale, AZ (US)

Correspondence Address: Lloyd W. Sadler;Parsons Behle & Latimer, Suite 1800, 201 South Main Street, Salt Lake City, UT, 84111, US

(73) Assignee: WebHound, Inc., Lindon, UT (US)

(21) Appl. No.: 10/672,643

(22) Filed: Sep. 27, 2003

(51) Int. Cl. G06F 15/16

(52) U.S. Cl. 709/202

(57) ABSTRACT

A system and method for managing the acquisition, updating and control of digital data files by a user or a central system, using a computer network for communication. The transfer, legalization and updating of such data files as audio files, video files, graphics files, text files and multimedia files is provided in an efficient economically effective manner.

### BACKGROUND OF INVENTION

1. Field of the Invention

This invention relates to methods and systems for updating digital content across a computer network. More specifically, this invention relates to methods and systems for controlling the update and/or access to the updated digital content data via one or more computer networks.

2. Description of Related Art

A variety of techniques have been proposed for managing the updating of digital content over a computer network. Generally, these prior techniques fail to adequately address the problem of detecting and recognizing unauthorized copies of digital data and/or fail to provide a mechanism for replacing such unauthorized digital data with authorized replacement versions of such digital data. Although it may not constitute prior art, the reader is hereby referred to U.S. Pat. No. 6,532,495 B1 which describes an Internet download enhancement system for general background-material. This patent is hereby-incorporated by reference in its entirety for the material contained therein.

Typical convention systems for updating digital content using a computer network deal only with updating authorized or properly licensed versions of the digital content. The techniques of these systems are generally performed via vendor released patches or updates to licensed and/or registered users or owners of the digital data. Typically, the users or owners of the digital data must specifically request from the vendors an update to the data. The users wishing such updates must use specific software on their computers and/or allow specific software and systems to access their systems and update their data. Examples of updated or updateable digital data include software programs and associated databases and help files that support such software programs, such as virus scanning programs and the respective database of virus signatures.

Software management technologies have also been developed to help enterprises manage the updating of digital data across their organizations. These system are typically centrally controlled by the enterprise's systems administrators and not by the individual computer users within the enterprise. Again, generally these systems do not determine if specific digital data is properly authorized or licensed. Nor do these systems have the ability to determine if a specific digital file (which may include text, graphical images, sound files and combinations thereof) is properly owned or licensed; and, if not, replace or update it with a properly licensed version, a close facsimile or an authorized derivative of the digital data file.

### SUMMARY OF INVENTION

In recent years, networking technologies, such as Peer-to-Peer (P2P) systems have proliferated not only among stand-alone computer users; but also business, government and university organizations worldwide. Although the commercial promise of P2P systems is substantial, the technology at present has mostly been used for the almost unrestrained transfer of unlicensed audio, video, graphical and software programs files and the like across computer networks. Such transfers have contributed greatly to economic losses in the recording and software industries and threaten publishing as well as film and television. In response to these losses the recording and software, industries have begun substantial campaigns of enforcing copyrights.

This invention addresses this problem by providing the technology for detecting the presence of specific digital files on a computing device, determining if the detected digital file(s) are properly licensed or owned by the owner of the computer device; requesting, downloading and installing a properly licensed, owned or updated file; and thereby facilitating the management, authorization and economic benefits of the copyrighted digital data files. Besides providing the mechanism for detecting unauthorized copies and providing authorized versions, this invention provides an efficient technique for individuals and organizations to ensure that the files stored on their computer systems are legal and authorized, thereby mitigating legal risks.

Accordingly, it is desirable to provide a method and system for managing the updating of licensed and unlicensed digital data files, which can be downloaded over a computer network. It is particularly desirable to provide a method and system for detecting unlicensed digital data content and to provide a method and system that can replace or update unlicensed digital data with licensed files, updates or authorized derivatives using a computer network.

Therefore, it is an object of this invention to provide a method and system for the management of digital data content using a computer network.

Another object of this invention is to provide a method and system for the management of digital data content that can detect whether one or more particular digital files are present on a networked electronic device.

A further object of this invention is to provide a method and system for the management of digital data content that includes the capability of replacing such digital content with an authorized version of the digital data content.

A still further object of this invention is to provide a method and system for the management of digital content where data files can be uploaded and/or downloaded to provide a licensed copy, update, or upgrade or authorized derivative of the detected digital files.

It is another object of this invention to provide a method and system for the management of digital content, over a computer network, that improves the management of downloadable and/or updateable intellectual property in an efficient, effective, accurate and functional manner.

Another object of this invention is to provide a method and system for the management of digital content that, in some embodiments, is compliant with the Digital Millennium Copyright Act of 1998.

A further object of this invention is to provide a method and system for the management of digital content that, in some embodiments, is compatible with P2P, shared file networks or the like.

A still further object of this invention is to provide a method and system for the management of digital content that, in some embodiments, is compatible with centralized digital data distribution networks or the like.

Another object of this invention is to provide a method and system for the management of digital content that, in some embodiments, is capable of tracking files over a computer network, tracking file downloads, and thereby protect the intellectual property rights of the owners of the digital data content.

It is another object of this invention to provide a method and system for the management of digital data content that is adapted to facilitate the commercialization of the digital data content.

It is a further object of this invention to provide a method and system for the management of digital data content that, in some embodiments, can be controlled by or from a centrally computer system, an individual end user, or by the combination of the two control methods.

It is a still further object of this invention to provide a method and system for the management of digital data content that, in some embodiments, provides scheduling of the detection and updating of digital data files.

Another object of this invention is to provide a method and system for the management of digital data content that, in the present embodiments, is easy to use and provides consumer privacy.

A further object of this invention is to provide a method and system for the management of digital data content that, in some embodiments, includes a searchable database of digital data content.

A still further object of this invention is to provide a method and system for the management of digital data content that, in some embodiments, includes the capability of building a searchable database of existing authorized and/or licensed digital data files.

A still further object of this invention is to provide a method and system for the management of digital data content that, in some embodiments, includes the capability of building a searchable database of existing unauthorized and/or unlicensed digital data files.

It is an object of this invention to provide a method and system for the management of digital data content that, in some embodiments, compares a built searchable database with other centrally located or distributed databases of digital content files.

It is a further object of this invention to provide a method and system for the management of digital data content that, in some embodiments, compares a searchable database with other P2P or standard file sharing system databases.

It is another object of this invention to provide a method and system for the management of digital data content that provides detection and updating of digital files over a computer network that, in the present embodiment, includes “watermarking” and/or indexing of digital files.

It is a still further object of this invention to provide a method and system for the management of digital data content that provides detection and updating of digital files over a computer network that in some embodiments uses “fingerprinting” and/or indexing of the digital data files.

In various embodiments of this invention some, all and/or combinations of the above cited objects and/or additional objects may be incorporated in this invention. Additional objects, advantages and other novel features of this invention will be set forth in part in the description that follows and in part will be apparent to those skilled in the art upon examination of the following or may be learned with the practice of the invention. Still other objects of the present invention will become readily apparent to those skilled in the art from the following description, wherein there is shown and described the present preferred embodiments of the invention, simply by way of illustration of the sever modes best suited to carry out this invention. The objects and advantages of this invention may be realized and attained by means of the instrumentalities and combinations particularly pointed out in the appended claims. As it will be realized, this invention is capable of other different embodiments, and its several details, specific components and steps are capable of modification in various aspects without departing from the concept of this invention. Accordingly, these objects and the following drawings and descriptions should be regarded as illustrative in nature and not as restrictive.

### BRIEF DESCRIPTION OF DRAWINGS

The accompanying drawings, incorporated in and forming a part of the specification, illustrate a present preferred embodiment of the invention. Some, although not all, alternative embodiments are described in the following description.

In the drawings:

FIG. 1 is a block diagram showing how a user accesses the system of this invention through a network, presently the Internet.

FIG. 2 is an illustration representing a typical user computer system connected to the network.

FIG. 3 is a diagram showing the storage of “agents” on the user's computer system, to enable the user's computer systems to use and contribute to the network using this invention.

FIG. 4 is a data flow diagram of the process of this current invention.

FIG. 5 is a diagram showing how a file is detected in this current invention.

FIG. 6 is a diagram showing how a file is updated in this current invention.

FIG. 7 is a top-level flow chart of the present process of this invention.

FIG. 8 is a detailed flow chart of the present process of this invention.

Reference will now be made in detail to the present preferred embodiment of the invention, an example of which is illustrated in the accompanying drawings.

### DETAILED DESCRIPTION

This invention is a method and system for updating digital content on a digital data storage device connected to a computer network. Typically, the digital data storage device is a personal computer system, although in alternative embodiments the digital data storage device could be any network compatible storage device including but not limited to music storage/players (such as MP3 players and the like), video storage/players, data content storage/display devices (such as email and/or database access devices), personal data assistant (PDA), and/or cell phone devices and the like. The computer network of the present embodiment of this invention includes but is not necessarily limited to the Internet. In further alternative embodiments, alternative computer networks can include local area networks, intranets, wide area networks and dial-up or the like communication connections. This invention updates digital data files that are content specific. This invention, in its present preferred embodiment includes the capability of detecting data files on a digital storage device, determining whether the detected data file is properly licensed or authorized, downloading updated and/or authorized files, managing the access to the unauthorized and/or authorized and/or updated data file content, and certifying the detected and downloaded data files.

Essentially, the concept of this invention is a system and process for detecting and swapping out “unlicensed”, “unauthorized” or out-of-date data files from a user's data storage device (hereinafter “digital computer system”) and replacing such data files with a “licensed”; “authorized” and/or updated data file. Access to the user's digital computer system is typically accomplished via a network, currently the Internet, but can also, in other embodiments, include access via an intranet, virtual private network (“VPN”) or the like. In its various embodiments, this invention can operates as a mandatory automatic process, or as a user or system administrator configured or scheduled process. The process of this invention can be set to run automatically, or can be used as an “as needed” tool by users and/or system administrators. This process, in its present embodiment, can be scheduled to run from either a central computer device, a user's computer, from another computing device or any combination of the above devices.

In its present embodiment, the process of this invention operates as one or more software “agents”. For the purpose of this disclosure “agent(s)” are defined as one or more computer software processes that perform one or more of the processes in this invention. These “agent(s)” are typically executable software running on a standard computational device having a programmable processor, memory and one or more interfaces, although in alternative embodiments, they may be embodied in dedicated hardware, firmware, software operating of a collection of computational devices or the combination thereof. These “agents” operate to (a) detect specific files (typically unlicensed files or files that are to be upgraded or updated); (b) create a data base of files to be swapped or updated; (c) compare files in the swap database with the files in a “master” database; (d) swaps out or updates the required file(s) if the licensed or updated file is found in the “master” database which matches or is “associated” with the file(s) in the created swap database; and (e) offers the user or system administrator the opportunity to choose to preview and/or give permission for the download (swap or update) of the respective file(s). The “master” database consists of a list of available licensed files and updated versions of files. These “agents” will typically reside on the user's personal computer within a P2P, stand alone or client/server system software client, although alternatively they may reside on a central server and other computing/digital data storage device. As noted above, although the “agents” are typically initiated and configured by the user, they may alternatively be initiated by a system administrator or by a file validation center. The user initialization and configuration includes identifying which files (digital data content) on the user's digital data storage device are to be scanned to determine if it is authorized or needs to be updated or upgraded. And, the “agents” may be run on an automatic basis, on a scheduled bases or on an ad-hoc basis per specific request. The “agents” can be configured, or controlled, by the user, system administrator, file validation center or any combination thereof to operate on specific files, specific digital data storage devices and/or over specific networks. The scanning agent scans or compares the file(s) marked by the user, administrator, file validation center, or any combination thereof to determine if they are “licensed” (authorized) and/or have available updates or upgrades. If a file is “unlicensed” or is eligible to be upgraded or updated, then an entry in the “candidate” database is created for the file of interest. An agent can be set to continuously update the “candidate” database, however, in the present embodiment, once the “candidate” database has been populated to any degree, an agent determines if the user's P2P client is “online”. If the client is “online” the central database of certified data files is accessed and searched for licensed or upgraded version of the files listed in the user's “candidate” database. Although typically this search is performed only when requested, an agent can be set to continuously scan for files listed in the “candidate” database. In an alternative embodiment, the “candidate” database fields are tagged with a specific identifier, which identifies the specific user. This tag is transmitted to the central servers for management, accounting and billing.

When the agent finds a match on the central database with a file identified in the “candidate” database, the agent requests the central server to download (or Upload) the appropriate file to the user's digital data storage device. This appropriate file, which may be an identical but authorized version of the previous identified file, an updated file, or an alternative file, is then downloaded (or uploaded) to the query database, typically alone with a tag to the specific indexed file that the “matched” or appropriate file is to replace or update. An agent periodically, continuously or as requested queries the query database for recently added “matched” files. Upon identifying any “matched” files in the query database, in the present embodiment, the agent prompts the user for confirmation that the user wants to either swap out the “matched” file for the index file; or if the user wishes to verify the “matched” file before swapping; or if the user wishes to cancel the operation. If the user chooses to cancel, the process terminates. If the user chooses to verify, the user is provided with a brief (presently 30 second) clip of the file for confirmation. After listening to or viewing the brief clip, the user is again provided the opportunity to confirm swapping, verifying or canceling the operation. If the user chooses to swap the files, the agent places a copy of the entire “matched” file in the user's specified data storage device, presently using standard P2P file imaging techniques, updates the user's file directory to show the new “matched” file, deletes the reference to the previous indexed file in the user's file directory, and in some embodiments further deletes the actual unauthorized, unlicensed or previous version of the indexed file from the user's digital data storage device. The deletion of the indexed file may be simply removing the reference to the file in the user's disk allocation/directory files, or may also include writing over the file so as to permanently remove the indexed file from stored memory. The type of deletion process used depends on the type of digital data content file and the requirements of the content file owner. In the present embodiment of the invention, the central servers do not track the individual transactions between the user and the central database, in alternative embodiments, this information can be tracked. Whether or not tracking is implemented again depends on the type of data content files being authorized or updated, the economic model being used for the collection of fees for authorized copies and the requirements of the content owner.

In alternative presently envisioned embodiments of this invention, the administration of the user's data storage device can be initiated on a remote computer device, with the agent being executed on the remote computer device, which may or may not be the central server computer, and using standard interface protocols to communicate with and access the user's digital data storage device, the central server and the central database. For example, the user could initiate the operation of this process from a remote location using a PDA or smart cell phone.

The following description and associated figure provide additional information concerning the structure and organization of the present mode of the invention for the purpose of simplifying the process of understanding the invention as previously described.

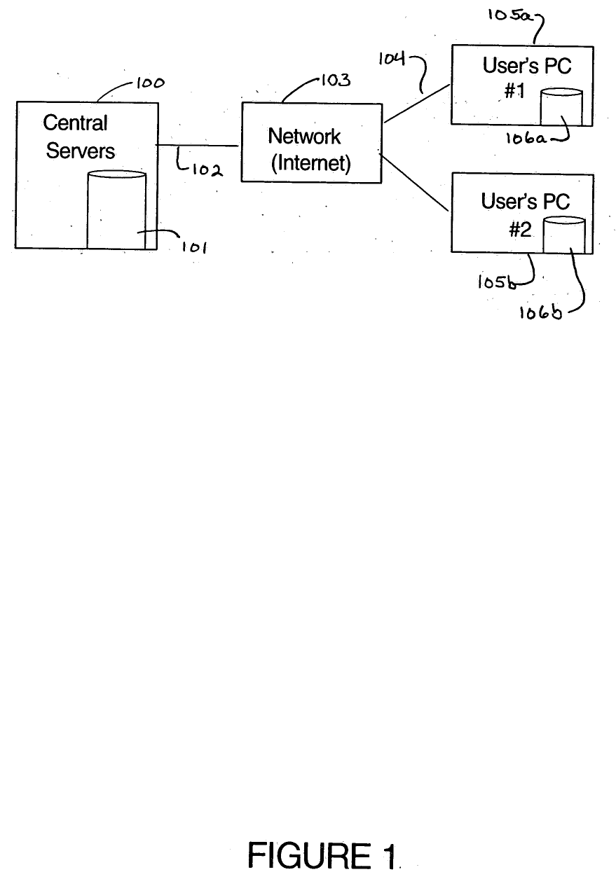

FIG. 1 shows a block diagram showing how a user accesses the system of this invention through a network, presently the Internet. The central server 100 includes or is in communication with the central database 101. The central server 100 in the present embodiment is a digital computer system capable of managing the process, controlling access to the central database 101 and in some embodiments it is on the central server 100 that the agent(s) performing the process of this invention are executed. The central server 100 is in communication 102 with a network 103. The present preferred network 103 is the Internet, although in alternative embodiments, the network 103 can be a local or wide area network. User computers 105a,b are also in communication 104 with the network 103. In this description, the term user computer is synonymous with user's digital data storage device. While in the present embodiment of the invention, the user's computer 105a,b is typically a personal computer having a long term storage device 106a,b such as a hard disk drive or a read/write CD/DVD drive, in alternative embodiments the user's computer 105a,b can be any other electronic device capable of storing digital data, including but not necessarily limited to audio players, video players, PDAs, cell phones, text/information storage and display devices. While “certified” or “licensed” data files are stored on the central database 101, “uncertified”, “unlicensed” or out-of-date data files are initially found on the user's computer 105a,b storage devices 106a,b. As noted above the agent performing the process of this invention may reside on the central server 100, the user's computer 105a,b or another computational device capable of communicating with the central server 100.

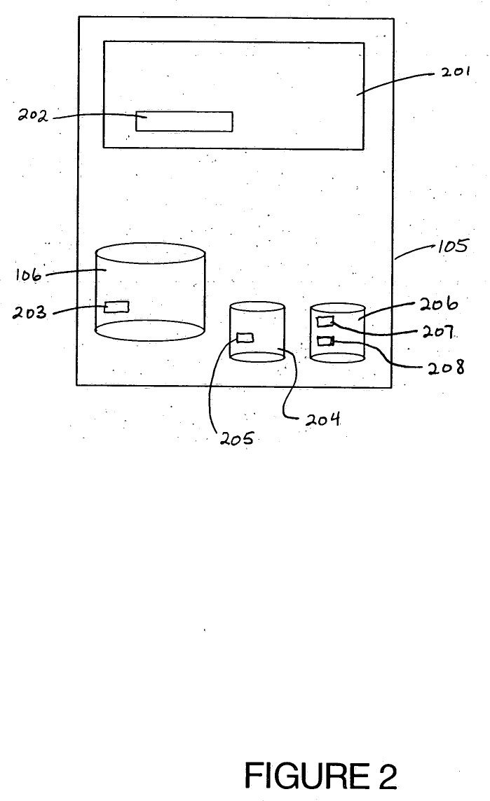

FIG. 2 shows an illustration representing a typical user computer system 105 connected 104 to the network 103, in particular showing the various files stored on the user's computer 105 of the present embodiment of the invention. In the Peer-to-Peer (P2P) configuration, a P2P software client 201 is stored-on the user's computer 105. Associated with the P2P software client 201 is an agent 202 adapted to execute the process of this invention. On the user's storage device 106 digital content files 203 are stored. The management of these digital content files 203 is the subject of this invention. These digital content files 203 may be authorized or unauthorized, updated or out-of-date, licensed or unlicensed. The digital content files 203 include, but are not limited to, such content as music files, video files, text files, software files, database files and combinations thereof. Also, stored on the user's computer system 105 are the “candidate” database 204 and the associated index file 205, the query database 206 and associated “matched” file references 207 and query file 208, containing a description of the “matched” files 207 referenced to the index for a specific index file 205. The databases and data files can be stored on one or more computer hard disk drive devices or any other read/write digital storage device.

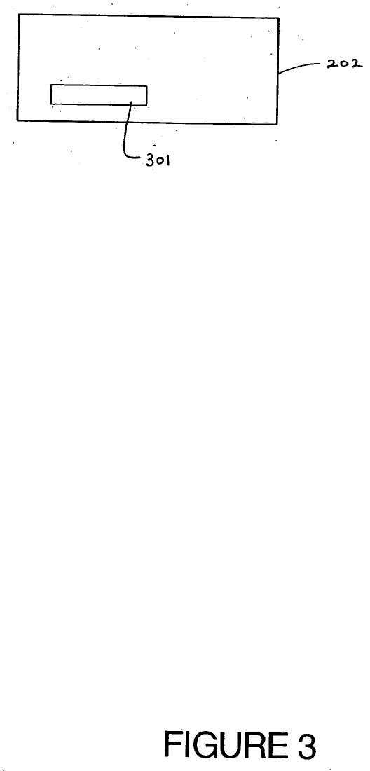

FIG. 3 shows a diagram showing the storage of “agents” 202 on the user's computer system 105, to enable the user's computer systems to use and contribute to the network 103 using this invention. Within or associated with the agent 102 is a user configuration and scheduling module 301. The purpose of the user configuration and scheduling module 301 is to control the files being searched for swapping and the scheduling of the detection/swapping process.

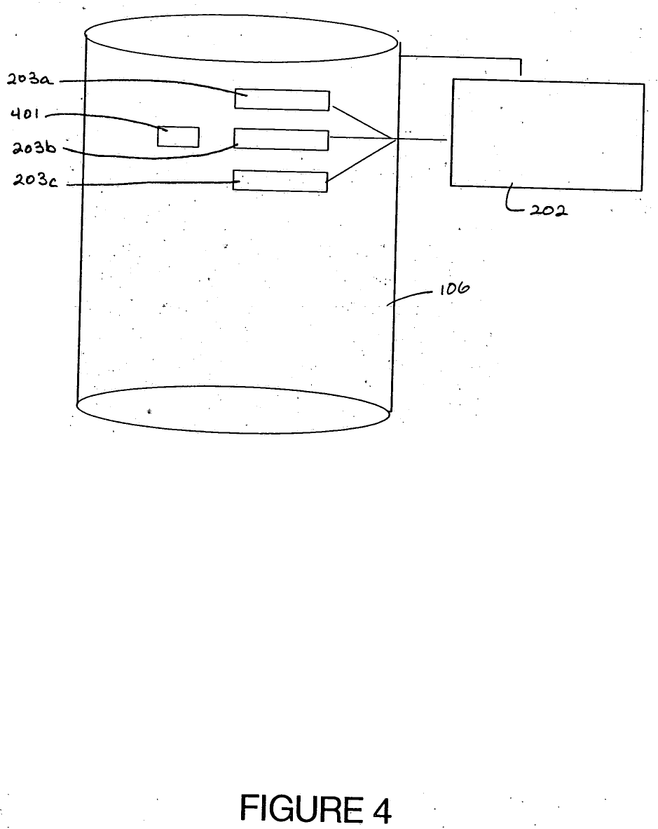

FIG. 4 shows a data flow diagram of the process of this current invention. The agent 202 communicates with the user's storage device 106. The storage device stores the users stored digital files, which include digital data files 203a,b,c and may include one or more certification tags 401, for, for example, a certified or licensed digital file. During typical operation, the user identifies for the agent 202 where the data files 203a,b,c of interest are stored. The agent 202 scans the data files 203a,b,c to determine if the files are licensed or not, and/or are to be upgraded or not. This identification step is typically accomplished during the user's configuration of the agent 202. In the present embodiment, the agent 202 will search for a “license” or “certification” tag 401 for each file. If such a tag 401 is not associated with a particular file, the file is considered “unlicensed” or “uncertified”. The agent 401 creates an index file entry for each “unlicensed” or “uncertified” file and references this index file entry to the “candidate” database.

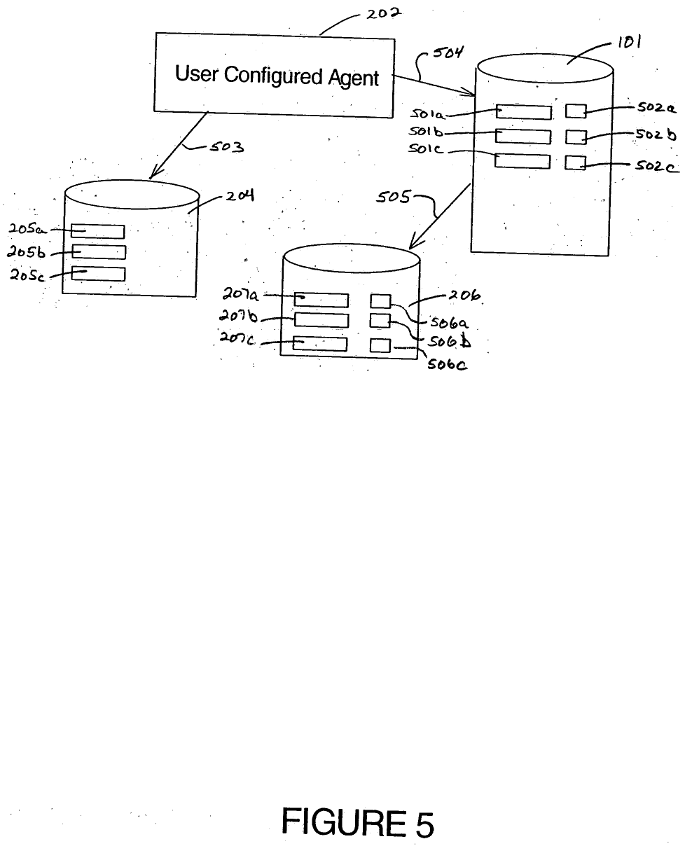

FIG. 5 shows a diagram showing how a file is detected in this current invention. This figure shows the communication between the agent 202, the user's “candidate” database 204 and the central database 101. The central database 101 stores licensed files and/or licensed and updated files 501a,b,c and the indexes 502a,b,c for the licensed files. The central database 101 communicates, via the central server 100 and the network 103 to the user's query database 206. The “candidate” database 204 includes index files 205a,b,c. The user's query database 206 includes the “matched” files 207a,b,c and the matched file references 506a,b,c. Typically, the process flow proceeds as follows: the index files 205a,b,c of the “candidate” database 204 are polled or queried 503, comparing 504 these files 205a,b,c with the licensed files 501a,b,c and associated indexes 502a,b,c in the central database 101. If an exact or approximate match is found, then the central database 101, via the central server 100, creates an index 506a,b,c for the licensed file 501a,b,c, a copy of the licensed file is created and identified as a “matched” file 207a,b,c and, in this embodiment, sends the matched file with its respective index 506a,b,c to the users query database 206.

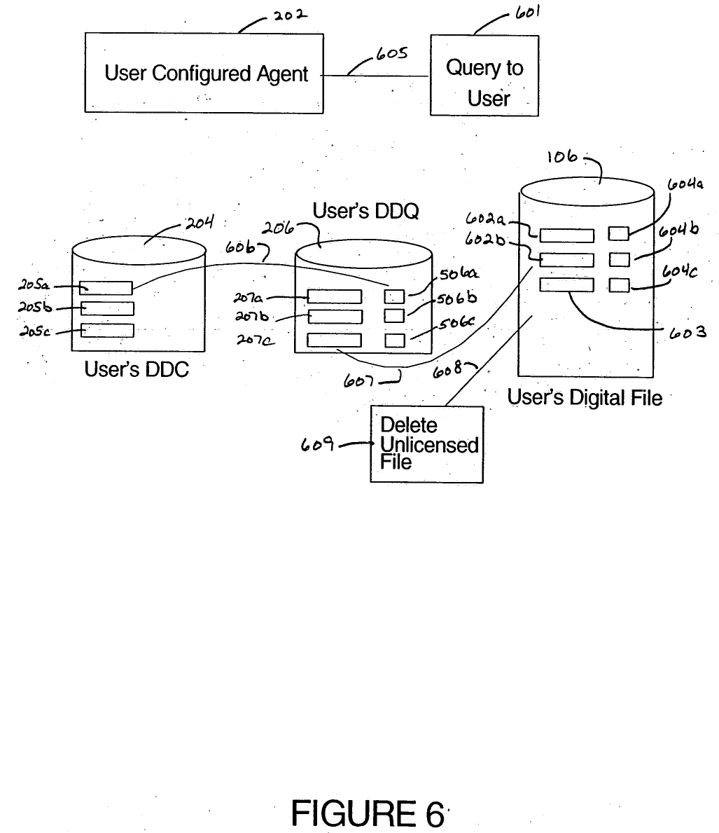

FIG. 6 shows a diagram showing how a file is updated in this current invention. Continuing the process described above in relation to FIG. 5, the agent 202 compares 606 the “matched” file indexes 506a,b,c with the index files 205a,b,c of the unlicensed files 602a,b. If they match, then the agent 202 sends 605 a query 601 to the user to determine if the user wants to preview a clip of the file prior to replacing with the matched file 207a,b,c the unlicensed file 602a,b. After receiving the user's permission to replace the unlicensed file 602a,b, the “matched” filed 207a,b,c is transferred 607 to the user's database 106, the unlicensed file 602a,b is deleted 608, removing the unlicensed file 609. The now authorized file 603 are marked as a licensed file 604a,b,c.

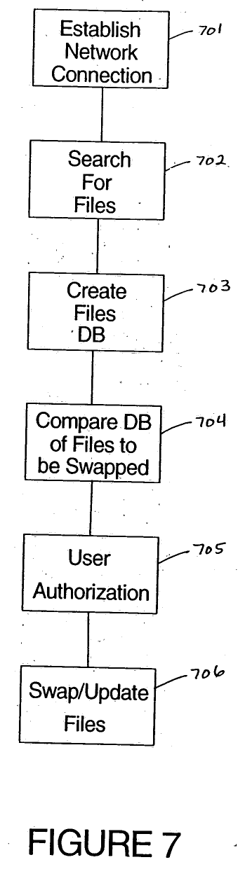

FIG. 7 shows a top-level flow chart of the present process of this invention. A network connection is established 701 between the user's digital data storage device 105 and the central server 100. Once the agent 202 performing this process is activated, a search 702 is made to determine if the user's database 106 contains “unauthorized” or upgradeable files. If such files are detected, then a database of the files to be swapped is created 703. The database of files to be swapped is compared 704 against a central database 101 containing all available authorized data files. If an appropriate data file is available, the user is queried for authorization 705. The user may request a preview of the swapped file, may cancel the transaction or may authorize the swap of the file. If the user authorizes the swap of the authorized (or upgraded) file for the unauthorized (or upgradeable) file, the swap is performed 706.

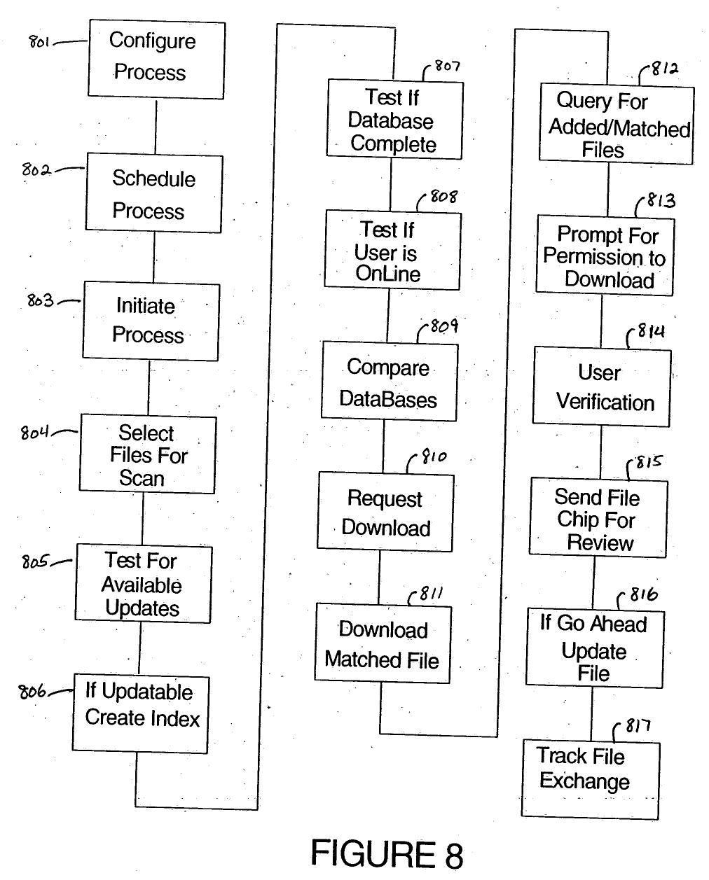

FIG. 8 shows a detailed flow chart of the present process of this invention. This FIG. 8 provides additional detail of the process of the present embodiment of the invention. In this embodiment, the user configures 801 the process for operation. Alternatively, the configure process 801 can also be preset or set on an ad hoc basis by a system administrator. The process is scheduled 801. This scheduling 801 can be periodic, continuous or as specifically requested. The process is initiated 801, thereby activating the agent. Files are selected 804 for scanning. A test 805 is made to determine which files have associated “authorized” or updated files available. If an “authorized” or updated file is available, an index of such files is created 806. A test 807 is made to determine if the database is complete, or ready for swapping. A test 808 is made to determine if the user computer is on-line, so that communication between the central database and the user's digital data storage device can be accomplished. The database of updateable files on the user's digital data storage device is compared 809 with the available update database. If matches are detected, a data file download is requested 810. The appropriate data file is downloaded 811. A query 812 is made to determine if there are additional matched files for download. If so, step 811 is repeated, if not a prompt 813 is sent to the user to get permission to download (or finalize the download), or alternatively the user and/or administrator could have previously set permissions to download (or finalize the download). If the user so requests, a verification 814 is provided by downloading 815 a clip for the user's review. If the user (or the system automatically) provides permission, the file is updated 816 or replaced with an authorized file. In some embodiments, the transaction is tracked 817 for accounting, management and billing.

Alternative embodiments of this invention can employ wireless communications network devices and systems, including wireless Internet, intranet, interactive television, satellite dish communications, television and personal recording devices and the like. Network platforms developed for Peer-2-Peer (P2P) or file sharing networks are applicable for the current embodiment of this invention. The present embodiments of this invention include stand-alone, remote access and/or client/server applications, using currently available file opener programs, browsers and media players, and are designed to accommodate such file sharing technologies as (a) audio multi-media file sharing, including but not limited to MP3, wav, digital art and the like; (b) video multi-media file sharing; (c) digital audio files; (d) digital video files; (e) wireless file streaming, sharing and transferring; (f) digital art, protected arts; (g) gaming art and gaming art file sharing; (h) digital text and graphics or digital text and graphics file sharing; and (i) computer programs and database information, including application programs, game programs, utility and operating system programs.

Therefore, although the present invention has been described in considerable detail, with particular reference to the present preferred embodiments, it is to be understood that the above described and referenced embodiments and examples are merely illustrative of the numerous and varied other embodiments and applications which may constitute applications of the principles of the invention. These example embodiments are not intended to be exhaustive or to limit the scope of this invention to the precise form, connections or choice of objects, platforms, computer language, process steps or modules disclosed herein as the present preferred embodiments. Modifications and/or variations are possible and foreseeable in light of the above teachings. The described embodiments of the invention were chosen and described to provide an illustration of the best mode of the principles of this invention known to the inventors and its practical application to thereby enable one of ordinary skill in the art to make and use the invention, without undue experimentation. Other alternative embodiments may be readily devised by those skilled in the art without departing from the spirit or scope of this invention, as determined by the appended claims when they are interpreted in accordance with the breadth to which they are fairly, legally and equitably entitled.

1. A system for the management of the distribution of digital data files, comprising:
(A) a user digital data storage device;
(B) a server computer device;
(C) a network providing communication between said user digital data storage device and said server computer device; and
(D) an agent stored on a device selected from the group consisting of said user digital data storage device, said server computer device and an additional electronic device, said agent being capable of detecting a particular file and swapping particular files out and replacing said particular file with a new file.

2. A system for the management of the distribution of digital data files, as recited in claim 1, wherein said user digital data storage device is selected from the group consisting of a personal computer, an audio player, a video player, a digital data access and display device.

3. A system for the management of the distribution of digital data files, as recited in claim 1, wherein said user digital storage device further comprises:
(1) a database of stored digital content files;
(2) a communications application program;
(3) a candidate database;
(4) a query database;
each of said database of stored digital content files, communications application program, said candidate database and said query database being stored on a read/write storage device.

4. A system for the management of the distribution of digital data files, as recited in claim 1, wherein said network is selected from the group consisting of the Internet, a local area network, a wireless network and a wide area network.

5. A system for the management of the distribution of digital data files, as recited in claim 1, wherein said agent further detects an unlicensed data file.

6. A system for the management of the distribution of digital data files, as recited in claim 1, wherein said agent further detects an upgradeable data file.

7. A system for the management of distribution of digital data files, as recited in claim 1, wherein said agent further replaces said particular file with a new file that is a licensed file.

8. A system for the management of distribution of digital data files, as recited in claim 1, wherein said agent further replaces said particular file with a new file that is an upgraded file.

9. A system for the management of distribution of digital data files, as recited in claim 1, wherein said agent further provides a user with a clip preview of said new file.

10. A method for the management of distribution of digital data files, comprising:
(A) detecting a particular file;
(B) determining if a file associated with said particular file is available in a database;
(C) determining if a user wishes said associated file to replace said particular file;
(D) if the user wishes said particular file be replaced with said associated file, transferring said associated file to a digital data storage device; and.
(E) removing said particular file from said digital data storage device.

11. A method for the management of distribution of digital data files, as recited in claim 10, wherein said particular file is an unlicensed file.

12. A method for the management of distribution of digital data files, as recited in claim 10, wherein said particular file is an upgradeable file.

13. A method for the management of distribution of digital data files, as recited in claim 10, wherein said associated file is a licensed file associated with said particular file.

14. A method for the management of distribution of digital data files, as recited in claim 10, wherein said associated file is an upgraded file associated with said particular file.

15. A method for the management of distribution of digital data files, as recited in claim 10, wherein said determination of the user's wish further comprises providing a clip of said associated file.

16. A method for the management of distribution of digital data files, as recited in claim 10, wherein said determination of the user's wish further comprises receiving permission to transfer said associated file to said digital data storage device.

17. A method for the management of distribution of digital data files, as recited in claim 10, wherein said detecting a particular file further comprises:
(1) searching for a digital data file; and
(2) determining if said digital data file is authorized.

18. A method for the management of distribution of digital data files, as recited in claim 17, wherein said digital data file is authorized if said digital data file is licensed and up-to-date.

19. A method for the management of distribution of digital data files, as recited in claim 10, wherein said particular file is selected from the group consisting of audio files, video files, text files, graphics files, multimedia files, program files and combinations of said audio, video text and graphics files.
